(19) United States
(12) Patent Application Publication
(10) Pub. No.: US 2006/0010489 A1
(43) Pub. Date: Jan. 12, 2006

(54) Method and system for enhancing security in wireless stations of a local area network (LAN)

(76) Inventors: Panayiotis E. Nastou, Attiki (GR); Panayiota Bay, Attiki (GR); Theodore Karoubalis, Peiraias (GR); Stelios Koutroubinas, Patras (GR)

Correspondence Address: SAWYER LAW GROUP LLP, P O BOX 51418, PALO ALTO, CA, 94303, US

(21) Appl. No.: 10/986,342

(22) Filed: Nov. 10, 2004

(30) Foreign Application Priority Data
Jul. 6, 2004 (GR) 20040100280

(51) Int. Cl. G06F 15/16; G06F 17/30; G06F 7/04; G06F 7/58; G06K 19/00; G06K 9/00; H04L 9/32

(52) U.S. Cl. 726/9

(57) ABSTRACT

Aspects for enhancing security in wireless stations of a local area network (LAN) are described. The aspects include utilizing a smart card to store sensitive data in a wireless station accessing a host in a wireless local area network (WLAN). Further included is providing a cryptographic token interface in the host for performing cryptographic operations with the sensitive data from the wireless station.

### FIELD OF THE INVENTION

The present invention is related to wireless LAN (802.11) security, and more particularly to the use of a smart card to enhance wireless LAN (WLAN) security.

### BACKGROUND OF THE INVENTION

Wireless communications have merited tremendous growth over the past few years, becoming widely applied to the realm of personal and business computing. Wireless access is quickly broadening network reach by providing convenient and inexpensive access in hard-to-wire locations. A major motivation and benefit from wireless LANs is increased mobility. Wireless network users are able to access LANs from nearly anywhere without being bounded through a conventional wired network connection. A key issue in the area of wireless and mobile communications is security.

The IEEE 802.11 standard for wireless LANs (WLANs) stands as a significant milestone in the evolution of wireless network technologies. In recent years, the members of a 802.11i task group have given great effort in order to provide WLAN users a more powerful security protocol. FIG. 1 illustrates how a wireless client application 10 in a host 11 and a wireless station 12 currently communicate. While only one host is shown, this is meant to be illustrative for the communications that occur between a host and wireless station in a WLAN. Of course, a plurality of systems would be expected to be present in a WLAN. For typical communications, the application 10 passes non-cryptographic operations to the station 12 through the station driver interface 14 of the host 11. The cryptographic operations of the 802.1X authentication are executed in the host 11. The certificates and the keys needed during authentication are stored into operating system (OS) repositories 16 of the host 11 and are retrieved by using operating system calls. This strategy of using the OS repositories makes the wireless station 12 less portable, since most of the critical data (certificates and private keys) for security is stored into a specific host. To use the station 12 in another host is difficult, since sensitive information must be transferred from one host to another. Further, storing sensitive data into public places and repositories is less secure, since malicious applications (worms, Trojans, etc.) can be used to retrieve such sensitive data during operating system operations.

Accordingly, a need exists for enhancing security with improved portability for stations in a WLAN that complements the capabilities of 802.1X. The present invention addresses such a need.

### SUMMARY OF THE INVENTION

Aspects for enhancing security in wireless stations of a local area network (LAN) are described. The aspects include utilizing a smart card to store sensitive data in a wireless station connected on a host which accesses a wireless local area network (WLAN). Further included is providing a cryptographic token interface in the host for performing cryptographic operations with the sensitive data from the wireless station.

Through the use of a smart card for stations in a WLAN in accordance with the present invention, portability is maintained without sacrificing security, as users are able to use the smart card when moving from one computer to another. Such ability to store sensitive data on a smart card also avoids dependency on a particular system and its operating system repository, thus reducing susceptibility to malicious applications. These and other advantages of the aspects of the present invention will be more fully understood in conjunction with the following detailed description and accompanying drawings.

### BRIEF DESCRIPTION OF THE DRAWINGS

FIG. 1 illustrates a block diagram of a wireless station and host of a WLAN of the prior art.

FIG. 2 illustrates a block diagram of a wireless station and host of a WLAN in accordance with the present invention.

FIG. 3 illustrates a block diagram of object classes for a Cryptoki interface in accordance with the present invention.

### DETAILED DESCRIPTION

The present invention relates to the use of a smart card to enhance wireless LAN (WLAN) security. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

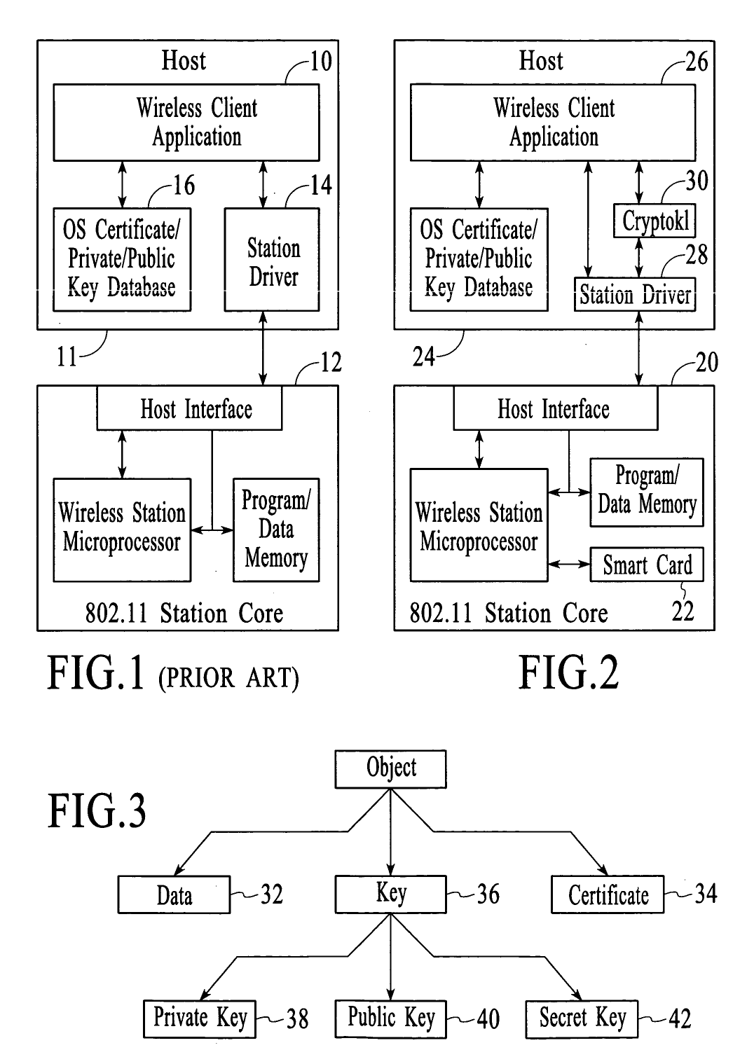

The present invention provides a WLAN station architecture that employs a smart card to allow users to move from one computer to another safely and seamlessly. FIG. 2 illustrates a block diagram of a system in accordance with the present invention that improves upon the system of FIG. 1. As shown, a wireless station 20 includes a smart card 22 storing sensitive data, the smart card 22 connecting to the wireless station 20 via a serial interface, for example. The storing of sensitive data by a smart card in accordance with the present invention includes all the sensitive information used by the chosen authentication method of 802.1X.

For example, for enterprise-sized environments, an authentication server is often used in the WLAN to support security operations according to a most secure and popular authentication method of EAP-TLS (extensible authentication protocol - transport layer security), the details of which are well known in the art. As is generally understood, for EAP-TLS, sensitive data being utilized includes a supplicant's private key, which is used to sign supplicant messages, the public key of a root certificate authority, which is used by the supplicant to verify the signature of a signed public-key certificate (signed with the private key of the root certificate authority), and a premaster secret. As is further generally understood, for non-enterprise (home or small business) environments, an authentication server may not be present. Under such circumstances, a preshared key (PSK) is often set, such that every user is to use the PSK when the user's supplicant is associated in the PSK mode. Thus, the PSK is static sensitive data which can be stored by a smart card in accordance with the present invention. Static WEP (______) keys may also be stored in non-enterprise environments

When the wireless station 20 with the smart card 22 connects to a host 24, non-cryptographic functions are passed from an application 26 of a host 24 to the station 20 through a station driver interface 28, while cryptographic operations are passed from the application 24 to the station 20 using a Cryptoki API 30.

The Cryptoki API 30 refers to cryptographic token interface application programming interface, as specified in the fundamental concepts of PKCS #11 (Public-Key Cryptographic Standard) well known in the art. The primary goal for Cryptoki is a low-level programming interface that abstracts the details of portable cryptographic devices, such as those based on smart cards, PCMCIA cards, and smart diskettes, and presents to the application 26 a common model of the cryptographic device, called a “cryptographic token” or simply token. FIG. 3 presents the three object classes that Cryptoki defines in accordance with the present invention. A data object 32 is defined by an application, a certificate object 34 stores a certificate, and a key object 36 stores a cryptographic key, which may be a private key 38, a public key 40, or a secret key 42. A token can create and destroy objects, manipulate them, and search for them. In addition to the cryptographic functions a token can perform, a token may also have an internal random number generator.

Whenever an application 24 is to gain access to the token's objects and functions, the application 24 opens one or more sessions. A session provides a logical connection between the application 24 and the token. The session can be read/write, such that the application can create, read, write, and destroy both public and private objects, or a session can be read-only, such that the application can only read private objects but can create, read, write, and destroy public objects. In accordance with the present invention, the cryptoki interface 30 recognizes two token user types, a security officer and a normal user. The role of the security officer is to initialize the token and to set the normal user's PINs (personal identification numbers), and possibly to manipulate some public objects. Private objects can be accessed by a normal user and that access is granted only if the normal user has been authenticated, i.e., the normal user cannot log in until the security officer has set the normal user's PIN.

A token may be used to perform some or all of the following functions included in the cryptoki API in accordance with the present invention: general purpose functions; token management functions; session management functions; object management functions; encryption/decryption functions; message digesting functions; signing and MAC-ing (media access controller) functions; functions for verifying signatures and MACs; dual-purpose cryptographic functions; key management functions; and random number generation functions. Since the smart card 22 can be used to provide cryptographic operations, e.g., random number generation, signing messages, verifying signatures and MACs, when designed to include a crypto-processor, the functions needing to be performed by the token depend upon those cryptographic capabilities chosen to be provided by the smart card 22, as is well appreciated by those skilled in the art. While providing cryptographic operations on the smart card 22 increases the complexity of the smart card 22, high security is realized, since the sensitive data stored on the smart card 22 need never leave it.

Thus, with the use of a smart card for stations in a WLAN in accordance with the present invention, users are able to move from one computer to another without the need to enter security related data for network access into each computer they are using. Since the security related data is stored safely in the smart card, users can enjoy the same network access privileges by plugging their WLAN station smart card (e.g., via PCMCIA, USB, etc.) in different computers. In this manner portability is ensured without sacrificing security and while avoiding operating system dependency, so as to reduce susceptibility to malicious applications.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for enhancing security in wireless stations of a local area network (LAN), the method comprising:
utilizing a smart card to store sensitive data in a wireless station connected on a host which accesses a wireless local area network (WLAN); and
providing a cryptographic token interface in the host for performing cryptographic operations with the sensitive data from the wireless station.

2. The method of claim 1 wherein utilizing a smart card to store sensitive data further comprises storing sensitive data of a chosen authentication method for the WLAN.

3. The method of claim 2 wherein storing sensitive data further comprises storing a supplicant private key, storing a public key of a root certificate authority, and storing a premaster secret for an EAP-TLS authentication method.

4. The method of claim 2 wherein storing sensitive data further comprises storing static WEP keys and a preshared key (PSK) for non-enterprise WLANs.

5. The method of claim 1 further comprising utilizing random number generation on the smart card.

6. The method of claim 1 further comprising utilizing a crypto-processor on the smart card.

7. The method of claim 1 wherein providing a crytographic token interface further comprises providing functionality for at least one of the group comprising general purpose functions, token management functions, session management functions, object management functions, encryption/decryption functions, message digesting functions, signing and MAC (media access controller) functions, functions for verifying signatures and MACs, dual-purpose cryptographic functions, key management functions, and random number generation functions.

8. A system for enhancing security in wireless stations of a local area network (LAN), the system comprising:
a wireless station, the wireless station utilizing a smart card to store sensitive data; and
a host, the host providing a cryptographic token interface for performing cryptographic operations with the sensitive data from the wireless station.

9. The system of claim 8 wherein the wireless station utilizing a smart card further stores sensitive data of a chosen authentication method for the WLAN.

10. The system of claim 9 wherein the sensitive data further comprises a supplicant private key, a public key of a root certificate authority, and a premaster secret for an EAP-TLS authentication method.

11. The system of claim 9 wherein the sensitive data further comprises static WEP keys and a preshared key (PSK) for non-enterprise WLANs.

12. The system of claim 8 wherein the wireless station further utilizes a smart card for random number generation.

13. The system of claim 8 wherein the wireless station further utilizes a crypto-processor on the smart card.

14. The system of claim 8 wherein the host providing a crytographic token interface further provides functionality for at least one of the group comprising general purpose functions, token management functions, session management functions, object management functions, encryption/decryption functions, message digesting functions, signing and MAC (media access controller) functions, functions for verifying signatures and MACs, dual-purpose cryptographic functions, key management functions, and random number generation functions.

15. A method for enhancing security in wireless stations of a local area network (LAN), the method comprising:
storing sensitive data of a chosen authentication method for a WLAN on a smart card; and
utilizing the smart card in a wireless station of the WLAN for secure access to a host of the WLAN.

16. The method of claim 15 wherein storing sensitive data further comprises storing a supplicant private key, storing a public key of a root certificate authority, and storing a premaster secret for an EAP-TLS authentication method.

17. The method of claim 15 wherein storing sensitive data further comprises storing static WEP keys and a preshared key (PSK) for non-enterprise WLANs.

18. The method of claim 15 further comprising utilizing a crypto-processor on the smart card.

19. The method of claim 15 further comprising providing a cryptographic token interface in the host for performing cryptographic operations with the wireless station.

20. The method of claim 19 wherein providing a cryptographic interfaces further comprises providing functionality for at least one of the group comprising general purpose functions, token management functions, session management functions, object management functions, encryption/decryption functions, message digesting functions, signing and MAC (media access controller) functions, functions for verifying signatures and MACs, dual-purpose cryptographic functions, key management functions, and random number generation functions.
